(19) United States
(12) Patent Application Publication
(10) Pub. No.: US 2006/0142500 A1
(43) Pub. Date: Jun. 29, 2006

(54) Multi-branched styrene-conjugated diene block copolymer and its preparation method

(76) Inventors: Kwan-Young Lee, Daejeon (KR); Nam-Sun Choi, Daejeon (KR)

Correspondence Address: KENYON & KENYON LLP, 1500 K STREET N.W., SUITE 700, WASHINGTON, DC, 20005, US

(21) Appl. No.: 11/358,131

(22) Filed: Feb. 22, 2006

Related U.S. Application Data
(63) Continuation-in-part of application No. 10/937,325, filed on Sep. 10, 2004.

(30) Foreign Application Priority Data
Feb. 17, 2004 (KR) 2004-10240

(51) Int. Cl. C08F 255/00; C08F 297/00

(52) U.S. Cl. 525/254; 525/314

(57) ABSTRACT

The present invention provides a multi-branched block copolymer of vinyl aromatic monomer and conjugated diene having a structure of general formula (S-D)m-R-D, where S represents a polymer of aromatic monomer, D represents a polymer of conjugated-diene monomer, R represents a conjugated diene copolymer containing randomly multi-placed condensing agents (Cn), in which C represents a condensing agent with following formula 1 and n represents the number of condensing agents. Further, condensing agent has a dual functionality for propagation and termination of polymerization. The multi-branched styrene-conjugated diene block copolymer has enhanced tensile strength and low solution viscosity compared to radial type block copolymer. Preparation process for these multi-branched block copolymer is also provided.

### RELATED APPLICATION

This application is continuation-in-part application of U.S. Ser. No. 10/937,325 filed on Sep. 10, 2004.

### BACKGROUND OF THE INVENTION

The present invention relates to a multi-branched styrene-conjugated diene block copolymer and its preparation method. More particularly, this invention relates to a multi-branched styrene-conjugated diene block copolymer having excellent mechanical property and processibility, prepared from styrene-conjugated diene diblock living copolymer with condensing agent. Further, branches connected to the block copolymer are styrene-conjugated diene diblocks and asymmetric in number average molecular weight.

The various block copolymers based upon vinyl aromatic monomer and conjugated diene monomer have been developed by the anionic polymerization methods. Triblock copolymer among them is regarded as a thermoplastic elastomer and excellent mechanical property has been shown for triblock copolymer with vinyl aromatic polymer end blocks such as polystyrene-block-polybutadiene-block-polystyrene(SBS) and polystyrene-block-polyisoprene-block-polystyrene(SIS).

The triblock copolymers can be classified as linear type and radial type according to the branch structure. Linear triblock copolymer can be manufactured by sequential polymerization method or coupling method. In the sequential polymerization method, A-B-A type linear copolymer is manufactured by polymerization of A monomer with anionic polymerization initiator followed by sequential addition and polymerization of B and A monomers. In the coupling method, (A-B)₂X type block copolymer is manufactured by i) forming A-B type diblock living anion through anionic polymerization; and ii) reacting the dilock anion with coupling agents such as dichlorodimethylsilane which has two functional groups capable to readily react with anions.

On the other hand, radial type block copolymer is manufactured by i) forming diblock of vinyl aromatic monomer and conjugated diene monomer by anionic polymerization; and ii) reacting with linking agent with multiple functional groups such as tetrachlorosilane. The radial block copolymer has a general structure of (A-B)nX, wherein A is a typically thermoplastic polymer block such as polystyrene, B is a elastomeric block such as polybutadiene or polyisoprene and X is a remainder of linking agent. In the above structure, n represents the number of branches. The block copolymer is in linear structure when n is 2, whereas the copolymer with 3 or higher n value has a radial shape. The value of n is limited and determined by the number of functional groups of the linking agent used.

Therefore, the structure of block copolymer, linear or radial type, can be controlled by the selection of coupling/linking agent to react with diblok copolymer anion. Functional group which reacts with living polymer anion include halogen and ester group. Various coupling agent or linking agent with more than two funcional groups are well known such as, 1,2-dibromoethane, ethyl acetate, silicon tetrachloride or hexachlorodisilane compounds. (Henyry L. Hsieh and Roderic P. Quirk, “Anionic Polymerization, Chapter 12, 13, Marcel Dekker, New York, 1996).

The radial type block copolymer prepared by using linking agent has a symmetric shape in which the length, the degree of polymerization and monomer compositions of branches are identical. Furthermore, polymer arms are connected together in the center.

Among various kinds of polymerization methods including radical polymerization, cationic polymerization and Zigler-Natta polymerization, anionic polymerization has a living character which facilitated the synthesis of polymer material with diversified functionality and structure through chemical modification of living end of polymer. Multi-branched block copolymer can be also prepared by taking advantage of living character of anionic polymerization. Further, the structure of branch and the composition of monomer can be controlled.

Various methods for manufacturing an asymmetric multi-branched block copolymer have been disclosed.

In U.S. Pat. No. 4,391,949, (A-B)x-Y-Cz type asymmetric radial block copolymer was disclosed. Asymmetry of branches was achieved by preparation of styrene-isoprene diblock living copolymer and isoprene living polymer in separate reactors through anionic polymerization and coupling of the mixture of the prepared polymer anions with multi-functional coupling agent, such as, divinylbenzene.

In U.S. Pat. No. 5,212,249 and U.S. Pat. No. 5,550,196, asymmetric radial copolymer has been prepared with following steps of i) preparing polydiene block using anionic polymerization method; ii) partly coupling said block by adding coupling agent, such as, tetrachlorosilane, 1,2-bis(trichlorosilyl)ethane in excess; and iii) coupling with styrene-diene diblock anion, separately prepared in another reactor, in the presence of polar modifier, such as, 1,2-dimethoxyethene or ethyleneglycol diethylether. Further, it has been also disclosed that this radial copolymer can be used as low viscosity adhesive composition.

However, the above mentioned methods require the use of at least two separate reactors to obtain an asymmetric radial copolymer.

On the other hand, in U.S. Pat. No. 5,446,093, asymmetric radial copolymer in the form of (An-Bm)x-Y—(C)z having 68 asymmetric branches has been prepared with following steps of i) preparing polystyrene block; ii) preparing the mixture of polystyrene-isoprene double block and polyisoprene block by adding sequentially alkyl lithium initiator and isoprene monomer to polystyrene block; iii) coupling the resulted mixture of polymer anions with coupling agent, such as, hexachlorodisiloxane in the presence of polar modifier, such as, diethoxyethane.

Coupling methods described above require the preparation of more than two kinds of living polymer anion to make asymmetric radial block copolymer. The obtained copolymer has a star shape in which the branches are connected in one place.

To obtain an asymmetric radial block copolymer, condensing method can be used other than coupling method. Condensing agent has a functional group such as vinyl group to propagate anionic polymerization and another functional group like halide or alkoxy group to terminate anionic polymerization in the same molecule. The dual functionality of condensing agent enables two kinds of reaction to take place to afford branch structure by anionic polymerization.

According to the literature (Macromolecules 2000, 33 and 3557, Macromolesules 2002, 35, 2055), it has been reported that branched polystyrene is prepared by the reaction of condensing agent, chlorodimethylsilylstyrene (CDMSS) and polystyrene living anion, and that triblock copolymer of the structure of branched polystyrene-block-linear polystyrene-block-branched polystyrene can be prepared by coupling branched polystyrene.

In U.S. Pat. No. 4,865,615 and U.S. Pat. No. 4,857,618, the copolymers prepared from the reaction of hydrocarbyl lithium initiator, anionically polymerizable compound and a condensing agent and their preparation methods are disclosed. In these disclosures, the mole ratio of condensing agent to initiator was suggested as 1/(1+m) when m is the number of terminating group in the condensing agent. Therefore, all the functional groups of condensing agent including vinyl group and halide group are consumed stoichimetrically by the reaction with polymer living anion and the number of generated branches are limited to the number of terminating functional group present in the condensing agent. Further, in U.S. Pat. No. 4,996,266, copolymer with multi-branched structure, which was prepared by coupling reaction of the condensed copolymer, also has been disclosed.

In U.S. Pat. No. 5,210,143, A-(B/Z)-A, [A-(B/Z)]yLz, [(A/Z)-B]yLz, [(A/Z)-(B/Z)]yLz types of elastomeric block copolymers prepared using functional condensing agent have been disclosed. In these formulas, A represents non-elastomeric polymer block consisting of vinyl aromatic compound; B represents conjugated-diene polymer block; Z represents condensing agent; and L represents multifunctional linking agent, such as, divinylbenzene. Symmetric branched block copolymer can be obtained by the reaction between living polymer anion and condensing agent, after complete formation of living polymer anion. Further, asymmetric branched block copolymer can be obtained by the reaction with living polymer anion and condensing agent in the presence of monomers. However, in this disclosure, there is no suggestion about multi-branched block copolymer using diblock copolymer anion.

On the other hand, the disclosure in U.S. Pat. No. 5,210,143 has not suggested that the ratio of condensing agent/anion initiator can vary the structure and numbers of branched copolymer block, which results from the simultaneous propagation of polymer block by anion initiator as well as the condensing reaction by condensing agent.

Commercially available radial type SBS block copolymer generally shows low melt flow index, high solution viscosity, low tensile strength and low elongation ratio compared to linear SBS block copolymer. The radial type SBS block copolymer has a symmetric structure having branches connected in one place and in general contains about 30 wt % of styrene.

Therefore, structure of branched block copolymer has yet to be developed to increase mechanical property, such as, tensile strength and to improve the processibility limited by high solution viscosity.

### SUMMARY OF THE INVENTION

The object of the present invention is to provide an asymmetric multi-branched block copolymer having 20,000˜1,000,000 number average molecular weight represented by formula
(S-D)m-R-D;

wherein,
S represents a polymer of at least one vinyl aromatic monomer selected from the group consisting of styrene, a-methylstyrene, o-methylstyrene, p-methylstyrene and p-tert-butylstyrene;
D represents a polymer of conjugated-diene monomer;
R represents a conjugated diene copolymer containing randomly multi-placed condensing agents (Cn), in which C represents a condensing agent with following formula 1 and n represents the number of condensing agents.
   m=nk+1, the ratio of n/m is 1>n/m>1/(k+1).

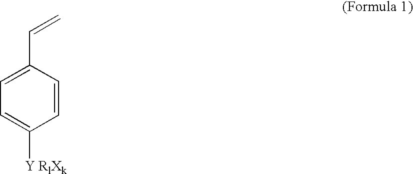

wherein,

Y represents Si or Sn atom; R is C1˜C20 alkyl or aryl; X is Cl or Br; and k, 1 is an integer of k+1=3.

Preferred vinyl aromatic monomer is styrene and preferred conjugated-diene monomer is butadiene. The desirable number average molecular weight of said branched copolymer is 50,000˜400,000. The contents of vinyl aromatic monomer is 10˜50 wt %.

According to the present invention, the preferred number average molecular weight of vinyl aromatic block is 10,000˜30,000 and preferred condensing agent is p-chlorodimethylsilylstyrene, p-dichloromethylsilylstyrene or p-trichlorosilylstyrene.

Another object of the present invention is to provide a method for preparing an asymmetric multi-branched block copolymer having 20,000˜1,000,000 number average molecular weight represented by formula (S-D)m-R-D comprising the steps of;

i) preparing vinyl aromatic living polymer by reacting alkyl lithium initiator and vinyl aromatic monomer in inert hydrocarbon solvent;

ii) preparing vinyl aromatic-conjugated diene diblock copolymer by adding and polymerizing conjugated-diene monomers to obtain vinyl aromatic living polymer in step i); and

iii) preparing multi-branched block copolymer by adding and reacting condensing agent and conjugated-diene monomers with obtained diblock copolymer in step ii);
(S-D)m-R-D;
wherein,
S represents a polymer of at least one vinyl aromatic monomer selected from the group consisting of styrene, a-methylstyrene, o-methylstyrene, p-methylstyrene and p-tert-butylstyrene;
D represents a polymer of conjugated-diene monomer;
R represents a conjugated diene copolymer containing randomly multi-placed condensing agents (Cn), in which C represents a condensing agent with following formula 1 and n represents the number of condensing agents.
   m=nk+1, the ratio of n/m is 1>n/m>1/(k+1).

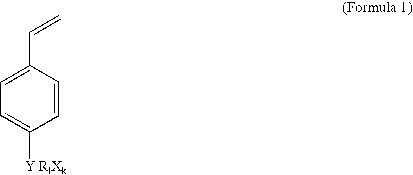

wherein,

Y represents Si or Sn atom; R is C1˜C20 alkyl or aryl; X is Cl or Br; and k, 1 is an integer of k+1=3.

The preferred alkyl lithium initiator is n-butyllithium, sec-butyllithium or tert-butyllithium.

### BRIEF DESCRIPTION OF DRAWING

FIG. 1 shows a schematic structure of multi-branched block copolymer of present invention.

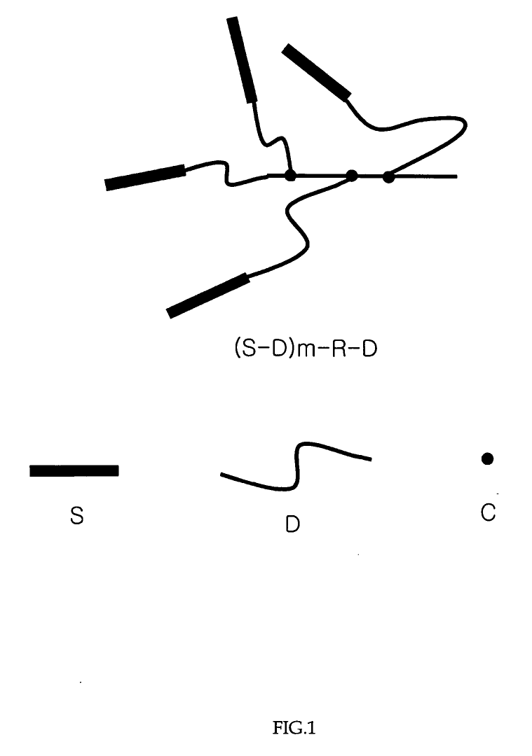

### DETAILED DESCRIPTION OF THE INVENTION

The multi-branched block copolymer of the present invention can be represented by formula; (S-D)m-R-D; wherein, S represents a polymer of at least one vinyl aromatic monomer selected from the group consisting of styrene, a-methylstyrene, o-methylstyrene, p-methylstyrene and p-tert-butylstyrene; D represents a polymer of conjugated-diene monomer; R represents a conjugated diene copolymer containing randomly multi-placed condensing agents (Cn), in which C represents a condensing agent with following formula 1 and n represents the number of condensing agents.
m=nk+1, the ratio of n/m is 1>n/m>1/(k+1).

The number average molecular weight of this block copolymer is 20,000˜1,000,000 and the contents of vinyl aromatic monomer is 10˜50 wt %. In the conjugated-diene block having more than 70% of 1, 4 structure.

In the formula, m is the number of diblock polymer branches; n is the mole number of condensing agent attached to the mult-branched block copolymer. The condensing agent represented by formula 1 has the functional group for propagation of anion polymerization and the other functional group for terminating anion polymerization in one molecule. The dual functionality provides the branched structure to the polymer main chain under anionic polymerization condition.

Added conjugated diene monomer into condensing reaction medium cause chain elongation of diblock polymer anion to take place simultaneously. Therefore, asymmetric multi-branched block copolymer with uneqal branch size is to be obtained.

According to the present invention, the ratio of condensing agent/anion initiator (n/m) is 1>n/m>1/(k+1). In this expression, k means the number of functional group for termination of anionic polymerization in condensing agent. When the ratio of condensing agent/anion initiator n/m=1/(k+1), all the functional groups of condensing agent are consumed by diblock polymer anion since total functionalities of condensing agent are equal to the amount of polymer anions. However, when the ratio n/m is larger than 1/(k+1), branched polymer anion formed by the initial reaction between condensing agent and diblock polymer anion can be regarded as a secondary polymer anion to react again with condensing agent added in excess. In this manner, branching reaction can be repeated and multi-branched block copolymer can be obtained.

The vinyl aromatic monomers of the present invention can be selected from styrene, a-methylstyrene, o-methylstyrene, p-methylstyrene and p-tert-butylstyrene. The preferred monomers can be selected from styrene, a -methylstyrene, o-methylstyrene and p-methylstyrene. The most preferred monomer is styrene.

The conjugated-diene monomers of the present invention can be selected from C4˜C20 conjugated-diene monomers. The preferred monomers can be selected from butadiene and isoprene. The micro structure of conjugated-diene block of the present invention has more than 70% of 1,4 structure and has about 10% of 1,2 structure controlled by adding ether compound, such as, tetrahydrofuran and amine compound, such as, tetramethylethylenediamine.

The condensing agent of the present invention can be selected from p-chlorodimethylsilylstyrene, p-dichloromethylsilylstyrene, p-trichlorosilylstyrene. Such condensing agent can have a dual role as a monomer with styrene-like double bond for polymerization and as a terminating agent with halogen functional group. The number of coupled polymer chain to condensing agent is governed by the number of substituted halogens.

The contents of vinyl aromatic polymers of the present multi-branched copolymer can be in the range of 10˜95%, preferably 10˜50%, more preferably 20˜40% to have proper mechanical strength, elongation ratio and processibility.

The number average molecular weight of vinyl aromatic polymer block can be in the range of 5,000˜40,000, preferably 10,000˜30,000. The number average molecular weight of total branched copolymer can be in the range of 20,000˜1,000,000, preferably 50,000˜400,000. If the properties of multi-branched copolymer of the present invention is compared to those of SBS radial block copolymer in the similar condition of number average molecular weight and styrene contents, improved processibility due to the lower solution viscosity and high tensile strength and elongation can be expressed.

The process for manufacturing multi-branched block copolymer of the present invention having 20,000˜1,000,000 number average molecular weight represented by formula (S-D)m-R-D comprises the steps of;

i) preparing vinyl aromatic living polymer by reacting alkyl lithium initiator and vinyl aromatic monomers in inert hydrocarbon solvent;

ii) preparing vinyl aromatic conjugated-diene diblock copolymer by adding and polymerizing conjugated-diene monomers to obtained vinyl aromatic living polymer in step i); and

iii) preparing multi-branched block copolymer by adding condensing agent and conjugated-diene monomers simultaneously to the diblock copolymer in step ii);

wherein,
S represents a polymer of at least one vinyl aromatic monomer selected from the group consisting of styrene, a-methylstyrene, o-methylstyrene, p-methylstyrene and p-tert-butylstyrene;
D represents a polymer of conjugated-diene monomer;
R represents a conjugated diene copolymer containing randomly multi-placed condensing agents (Cn), in which C represents a condensing agent with following formula 1 and n represents the number of condensing agents.
   m=nk+1, the ratio of n/m is 1>n/m>1/(k+1).

The process for manufacturing multi-branched block copolymer of the present invention can be explained more in detail as follows.

In the first polymerization step, vinyl aromatic living polymer block is prepared until all the vinyl aromatic monomers are completely polymerized in the inert hydrocarbon solvent using alkyl lithium initiator. The vinyl aromatic monomer can be selected from styrene, a-methylstyrene, o-methylstyrene, p-methylstyrene and p-tert-butylstyrene. The preferred monomer can be selected from styrene, a-methylstyrene, o-methylstyrene and p-methylstyrene. The most preferred monomer is styrene.

The conjugated-diene monomer can be selected from C4˜C20 conjugated-diene monomer. The preferred monomer is butadiene or isoprene. The solvent for polymerization can be selected from inert hydrocarbon solvent known for anionic polymerization. The preferred solvent can be selected from cyclic hydrocarbon solvent, such as, cyclohexane or cyclopentane, linear hydrocarbon solvent, such as, n-hexane or n-heptane, aromatic hydrocarbon solvent, such as, benzene, toluene or xylene. The most preferred solvent can be selected from cyclohexane, a mixture of cyclohexane and n-hexane and a mixture of cyclohexane and n-heptane.

The alkyl lithium initiator can be selected from alkyl lithium compound generally known to initiate anionic polymerization. The preferred alkyl lithium initiator can be selected from n-butyl lithium, sec-butyl lithium and tert-butyl lithium.

In the second polymerization step, vinyl aromatic-conjugated diene diblock copolymer is prepared by adding conjugated-diene monomer to the vinyl aromatic living polymer anion. Then, in the third polymerization step, asymmetric multi-branched block copolymer is prepared by adding condensing agent and conjugated-diene monomers together to the diblock copolymer in the second polymerization step.

When the condensing agent alone is added without conjugated diene monomer in the third step, a radial type symmetric block copolymer is formed.

The polymerization temperature can be the same or different in each polymerization step. The range of polymerization temperature can be 30˜150° C., preferably 50˜100° C. All polymerization steps have to be carried out in the presence of inert gas, such as, nitrogen or argon.

The present invention is described more concretely by following examples, but the scope of the present invention shall not be limited by following examples.

### EXAMPLE I

### Preparation of Long Branched Block Copolymer

A 2 L reactor was purged with argon gas. 960 g of purified cyclohexane and 48 g of styrene were added. The polymerization reaction was initiated by adding n-butyllithium 2.95 mmol (1.3M solution in cyclohexane) at 70° C. After 10 minutes from the peak temperature, 75 g of butadiene was added and polymerized. After 5 minutes from the peak temperature, 37 g of butadiene and 0.32 ml of p-chlorodimethylsilylstyrene were added simultaneously for coupling reaction and polymerization. A small amount of methanol was added to terminate the polymerization reaction, and anti-oxidant was added. Solvent was removed by steam stripping of polymerization solution and then, white crumb shape of polymer was obtained. The polymer crumb was dried by roll mixing.

### EXAMPLE II

### Preparation of Medium Branched Block Copolymer

A 2 L reactor was purged with argon gas. 960 g of purified cyclohexane and 48 g of styrene were added. The polymerization reaction was initiated by adding n-butyllithium 2.95 mmol (1.3M solution in cyclohexane) at 70° C. After 10 minutes from the peak temperature, 56 g of butadiene was added and polymerized. After 5 minutes from the peak temperature, 56 g of butadiene and 0.32 ml of p-chlorodimethylsilylstyrene were added simultaneously for coupling reaction and polymerization. A small amount of methanol was added to terminate the polymerization reaction, and anti-oxidant was added. Solvent was removed by steam stripping of polymerization solution and then, white crumb shape of polymer was obtained. The polymer crumb was dried by roll mixing.

### EXAMPLE III

### Preparation of Short Branched Block Copolymer

A 2 L reactor was purged with argon gas. 960 g of purified cyclohexane and 48 g of styrene were added. The polymerization reaction was initiated by adding n-butyllithium 2.95 mmol (1.3M solution in cyclohexane) at 70° C. After 10 minutes from the peak temperature, 37 g of butadiene was added and polymerized. After 5 minutes from the peak temperature, 75 g of butadiene and 0.32 ml of p-chlorodimethylsilylstyrene were added simultaneously for coupling reaction and polymerization. A small amount of methanol was added to terminate the polymerization reaction, and anti-oxidant was added. Solvent was removed by steam stripping of polymerization solution and then, white crumb shape of polymer was obtained. The polymer crumb was dried by roll mixing.

### COMPARATIVE EXAMPLE I

### Preparation of Radial Type Block Copolymer

A 2 L reactor was purged with argon gas. 960 g of purified cyclohexane and 48 g of styrene were added. The polymerization reaction was initiated by adding n-butyllithium 2.95 mmol (1.3M solution in cyclohexane) at 70° C. After 10 minutes from the peak temperature, 112 g of butadiene was added and polymerized. After 5 minutes from the peak temperature, 1.55 ml of tetrachlorosilane solution (0.5M in cyclohexane) was added for coupling reaction. A small amount of methanol was added to terminate the polymerization reaction, and anti-oxidant was added. Solvent was removed by steam stripping of polymerization solution and then, white crumb shape of polymer was obtained. The polymer crumb was dried by roll mixing.

### EXAMPLE IV

Analysis of Number Average Molecular Weight

The number average molecular weight of polymer was analyzed using Separation's module Waters 2690 equipped with differential refractometer Waters 410. Elution was carried out through a series of Styragel HR 5E, Styragel HR 4, and Styragel HR 2 columns using THF solvent at the flow of 0.3 mL/min. Column temperature was set at 41° C. number average molecular weight was determined from RI response to polystyrene standard. Table 1 shows the resulted number average molecular weight.

Analysis of Microstructure of Copolymer and Contents of Copolymer

The microstructure of copolymer and contents of styrene and butadiene in the copolymer were determined in chloroform-d solvent by using Bruker NMR-200 and NMR400 spectrometers.

Measurement of Solution Viscosity

Samples were dissolved in toluene in a 5.23 wt % concentration. The measurement of solution viscosity of copolymer was performed using Ubbelohde viscometer tube at 25° C.

Measurement of Mechanical Properties

Polymer sheet of 1 mm thickness was prepared using hot press from the roll mill dried polymer obtained in Examples 1˜3 and Comparative Example 1. Dumbbell type of test specimen were cut out from the pressed sheets and the mechanical properties were measured using Instron universal test machine Table 1 shows the resulted mechanical properties.

TABLE 1

| | Comp. | | | |
|---|---|---|---|---|
| | Exp. No. | Example No. | | |
| | 1 | 1 | 2 | 3 |
| styrene (g) | 48 | 48 | 48 | 48 |
| butadiene (g) | 112 | 75/37 | 56/56 | 37/75 |
| Mn of diblock (g/mol) | 114,300 | 81,200 | 58,900 | 42,900 |
| Mn of block copolymer (g/mol) | 377,700 | 345,100 | 292,900 | 282,700 |
| diblock contents | 9 | 12 | 6 | 5 |
| in copolymer (%) | | | | |
| Mn of block copolymer/ | 3.30 | 4.25 | 4.97 | 6.59 |
| Mn of diblock | | | | |
| tensile strength (kgf/cm2) | 160 | 230 | 190 | 230 |
| tensile elongation (%) | 680 | 760 | 810 | 870 |
| 300% modulus (kgf/cm2) | 28 | 30 | 25 | 27 |
| solution viscosity (cps) | 21 | 17.51 | 15.60 | 16.57 |

From this table, the multi-branched block copolymer of the present invention has enhanced tensile strength and elongation compared to those of radial type block copolymer. Further, the multi-branched block copolymer of the present invention shows lower solution viscosity than that of radial type block copolymer.

What is claimed is:

1. A multi-branched block copolymer having 20,000˜1,000,000 number average molecular weight represented by formula
(S-D)m-R-D;
wherein,
S represents a polymer of at least one vinyl aromatic monomer selected from the group consisting of styrene, a-methylstyrene, o-methylstyrene, p-methylstyrene and p-tert-butylstyrene;
D represents a polymer of conjugated-diene monomer;
R represents a conjugated diene copolymer containing randomly multi-placed condensing agents (Cn), in which C represents a condensing agent with following formula 1 and n represents the number of condensing agents.
m=nk+1, the ratio of n/m is 1>n/m>1/(k+1) 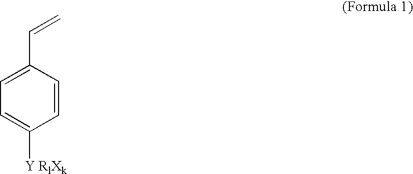
wherein,
Y represents Si or Sn atom;
R is the same or different alkyl of C1˜C20 or aryl;
X is the same or different Cl or Br; and
k, 1 is an integer of k+1=3.

2. The multi-branched block copolymer according to claim 1, wherein said vinyl aromatic monomer is styrene and said conjugated-diene monomer is butadiene.

3. The multi-branched block copolymer according to claim 1, wherein the number average molecular weight of said branched copolymer is 50,000˜400,000.

4. The multi-branched block copolymer according to claim 1, wherein contents of vinyl aromatic monomer is 10˜50 wt %.

5. The multi-branched block copolymer according to claim 1, wherein number average molecular weight of vinyl aromatic polymer is 10,000˜30,000.

6. The multi-branched block copolymer according to claim 1, wherein said condensing agent is p-chlorodimethylsilylstyrene, p-dichloromethylsilylstyrene or p-trichlorosilylstyrene.

7. A method for preparing a multi-branched block copolymer having 20,000˜1,000,000 number average molecular weight represented by formula (S-D)m-R-D comprising the steps of;
i) preparing vinyl aromatic living polymer by reacting alkyl lithium initiator and vinyl aromatic monomer in the presence of inert hydrocarbon solvent;
ii) preparing vinyl aromatic conjugated-diene diblock copolymer by adding and polymerizing conjugated-diene monomers to obtained vinyl aromatic living polymer in step i); and
iii) preparing multi-branched block copolymer by adding and reacting condensing agent and conjugated-diene monomers to the obtained diblock copolymer in step ii);
wherein,
(S-D)m-R-D;
wherein,
S represents a polymer of at least one vinyl aromatic monomer selected from the group consisting of styrene, a-methylstyrene, o-methylstyrene, p-methylstyrene and p-tert-butylstyrene;
D represents a polymer of conjugated-diene monomer;
R represents a conjugated diene copolymer containing randomly multi-placed condensing agents (Cn), in which C represents a condensing agent with following formula 1 and n represents the number of condensing agents.
m=nk+1, the ratio of n/m is 1>n/m>1/(k+1) 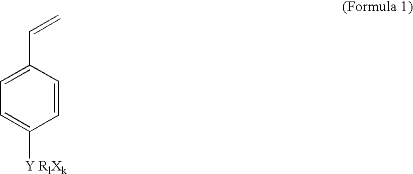
wherein,
Y represents Si or Sn atom;
R is C1˜C20 alkyl or aryl;
X is Cl or Br; and
k, 1 is an integer of k+1=3.

8. The method for preparing a multi-branched block copolymer according to claim 7, wherein said alkyl lithium initiator is n-butyllithium, sec-butyl-lithium or tert-butyllithium.
